(19) United States
(12) Patent Application Publication
(10) Pub. No.: US 2025/0267749 A1
(43) Pub. Date: Aug. 21, 2025

(54) RADIO RESOURCE CONTROL INACTIVE OPTIMIZATION SYSTEM AND METHOD

(71) Applicant: T-Mobile Innovations LLC, Overland Park, KS (US)

(72) Inventor: Jasinder P. SINGH, Olathe, KS (US)

(21) Appl. No.: 18/582,995

(22) Filed: Feb. 21, 2024

(51) Int. Cl. H04W 76/20; H04W 8/22; H04W 28/02; H04W 68/02

(52) U.S. Cl. CPC H04W 76/20; H04W 8/22; H04W 28/0268; H04W 68/02

(57) ABSTRACT

Methods and systems provided herein optimize usage of RRC inactive state. A method includes identifying a wireless device supporting a radio resource configuration (RRC) inactive state and determining, based on a wireless device profile or an active application utilized by the wireless device that the wireless device is not eligible to utilize the RRC inactive state. The method further includes selectively deactivating a capability for RRC inactive state and RNA paging for the wireless device based on the determination.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

With the emergence of 5G standalone networks, a new state, radio resource configuration (RRC) inactive state has been introduced to support low latency use cases and reduce excessive signaling. Prior to the introduction of RRC inactive state, wireless devices or user equipment (UEs), when inactive, were transitioned to an RRC idle state. To initiate the RRC idle state, the connection between the access node and the wireless device is released and a new connection is required in order to re-establish connectivity. However, with the RRC inactive state, both the wireless device and the access node store all information necessary (UE radio protocol information) to resume the prior connection, thus minimizing the eliminating the signaling to the core network that is necessary to reestablish a connection from the RRC idle state. Accordingly, the RRC inactive state can lead to enhanced performance for low latency applications and reduced power consumption for wireless devices.

The RRC inactive state introduces the concept of radio notification area (RNA), which is defined per UE and is configured at gNBs. The RNA is a combination of cells forming a paging area for the wireless device so that the gNB can send a first page to reach the UE quickly when a transition from RRC inactive state to active or connected state is required. However, if a UE in an RRC inactive state crosses RNA boundaries, then the UE is required to send an RNA update to one or more additional gNBs causing additional signaling. This scenario results in several disadvantages. First, if the UE fails to send the update upon moving to a different RNA, the first page from the gNB will be missed and the UE will not receive the latency benefit expected from using the RRC inactive state. Additionally, the excessive signaling can negatively impact the network. Accordingly, a solution is needed for optimizing RRC inactive usage to overcome these and other disadvantages.

### OVERVIEW

Exemplary embodiments provided herein include a method for optimizing the use of RRC inactive state. A method includes identifying a wireless device supporting a radio resource configuration (RRC) inactive state. The method further includes determining, based on a wireless device profile or an active application utilized by the wireless device that the wireless device is not eligible to enter RRC inactive state. Based on this determination, the method includes selectively deactivating the ability of the wireless device to enter RRC inactive state, thus requiring the wireless device to utilize RRC idle mode. Accordingly, the device is unable to utilize RNA paging and instead utilizes a paging area defined by a tracking area code (TAC) for the wireless device.

In a further embodiment, a system is provided including at least one communication interface, a memory storing instructions, and a processor executing the stored instructions to perform multiple operations. The operations include identifying a wireless device supporting an RRC inactive state and selectively deactivating the capability to utilize RRC inactive state for the wireless device based on wireless device information. The operations further include utilizing RRC idle mode and a paging area defined by the TAC instead of RNA paging upon deactivation of the RRC inactive state capability.

Additional embodiments include a method for optimizing RRC inactive state usage in a network. The method includes selectively deactivating RRC inactive capabilities for a wireless device based on wireless device information. The method further includes triggering a transition of the wireless device to RRC idle mode upon detecting a threshold period of inactivity, thereby requiring the wireless device to utilize a paging area defined by TAC in order to re-establish a connection.

In yet an additional embodiment, a non-transitory computer-readable medium stores instructions executed by a processor to perform multiple operations. The operations include selectively deactivating RRC inactive capabilities for a wireless device based on wireless device information. The operations further include transitioning the wireless device to RRC idle mode upon detecting a threshold period of inactivity, thereby requiring the wireless device to utilize a paging area defined by a TAC in order to re-establish a connection.

### BRIEF DESCRIPTION OF THE DRAWINGS

FIG. 1 depicts an exemplary environment for an RRC inactive optimization system in accordance with an embodiment.

FIG. 2 depicts an RRC inactive optimization system in accordance with an embodiment.

FIG. 3 depicts an exemplary access node in accordance with an embodiment.

FIG. 4 depicts an exemplary method for dynamically optimizing RRC inactive state for wireless devices in a network in accordance with an embodiment.

FIG. 5 depicts an exemplary method for eligibility determination for RRC inactive state in accordance with an embodiment.

FIG. 6 depicts an exemplary method for RRC inactive optimization in accordance with an embodiment.

FIG. 7 depicts an additional exemplary method for implementing RRC inactive optimization in accordance with an embodiment.

### DETAILED DESCRIPTION

In embodiments disclosed herein, an RRC inactive optimization system determines based on wireless device information whether the wireless device is eligible for entering the RRC inactive state or whether the wireless device will be required to enter RRC idle mode. While many wireless devices support the RRC inactive state, using the RRC inactive state in some cases may detrimentally impact the network or the performance of the wireless device itself due to the RNA paging protocol utilized to reconnect from RRC inactive to RRC connected mode.

As set forth above, the RRC inactive state was introduced with 5G to support low latency use cases and reduce signaling when the UE goes from the RRC inactive state to a connected state. To facilitate this transition, both the UE and the gNB store the necessary information to resume the connection. Thus, the RRC inactive state enables time efficiency, minimal signaling, and minimal UE power consumption. However, the RRC inactive state introduces the concept of RNA paging, which is defined per UE and is configured at an associated gNB. The RNA is the paging area for the UE where the gNB can send a first page so that the UE can be reached quickly when transitioning from the RRC inactive state to the RRC connected state. However, if a UE in the RRC inactive state crosses RNA boundaries, the UE has to send the RNA update to additional gNBs, thus causing additional signaling. Further, if the RNA update is not sent and the UE moves to different RNA, the first page will be missed and there will be no latency benefits for the UE.

Embodiments disclosed herein selectively utilize the RRC inactive state and RNA paging. Accordingly, embodiments disclosed herein enable this feature only on particular wireless devices, such as, for example home wireless devices or wireless devices having a particular quality of service class identifier (QCI). Accordingly, for roaming wireless devices or wireless devices having a different QCI from the particular QCI, the RRC inactive state will not be offered even if the wireless devices support the RRC inactive functionality. Accordingly, some wireless devices, for example, wireless devices connecting to the network through a particular public land mobile network (PLMN) will be treated as ineligible for the RRC inactive state despite a contrary indication in the UE capability report showing support for the RRC inactive state. For example, because the wireless device supports RRC inactive, it will send a UE capability report to the gNB indicating this support. However, system information block (SIB) 2 may include a list of PLMNs that are eligible for the RRC inactive state and if the PLMN associated with the wireless device does not support the RRC inactive state, the wireless device will instead utilize RRC idle mode.

Further, the access node or gNB can obtain UE profile information from the access and mobility function (AMF) of the core network. The optimization system will cause the wireless devices ineligible for RRC inactive state to revert to RRC idle mode after a period of inactivity and will use the paging areas and the TAC defined at the AMF. By selectively controlling RRC inactive eligibility, embodiments provided herein control which wireless devices send RNA updates and which cannot, thus resulting in reduced traffic from RNA messages and signaling.

In yet additional embodiments, the optimization system utilizes network slices to support different applications, including low latency applications. The slice activation can be dynamically determined based on the application being utilized by the wireless device. A particular slice may be activated for delay sensitive applications. RRC inactive state will be enabled because RRC inactive state is particularly beneficial for applications requiring low latency. If the delay-sensitive slice is not activated, the wireless device is not eligible for RRC inactive state. If the slice for delay sensitive applications is activated, the wireless device is eligible to utilize RRC inactive state and RNA paging.

An exemplary system described herein includes at least an access node (or base station), such as an eNodeB, a next generation NodeB (gNodeB), and a plurality of end-user wireless devices. For illustrative purposes and simplicity, the disclosed technology will be illustrated and discussed as being implemented in the communications between an access node (e.g., a base station) and a wireless device (e.g., an end-user wireless device

In addition to the systems and methods described herein, non-transitory computer-readable mediums may store the operations for the instructions or methods. Further, processing nodes on the network may execute the instructions or methods. The processing node may include a processor included in the access node or a processor included in any controller node in the wireless network that is coupled to the access node.

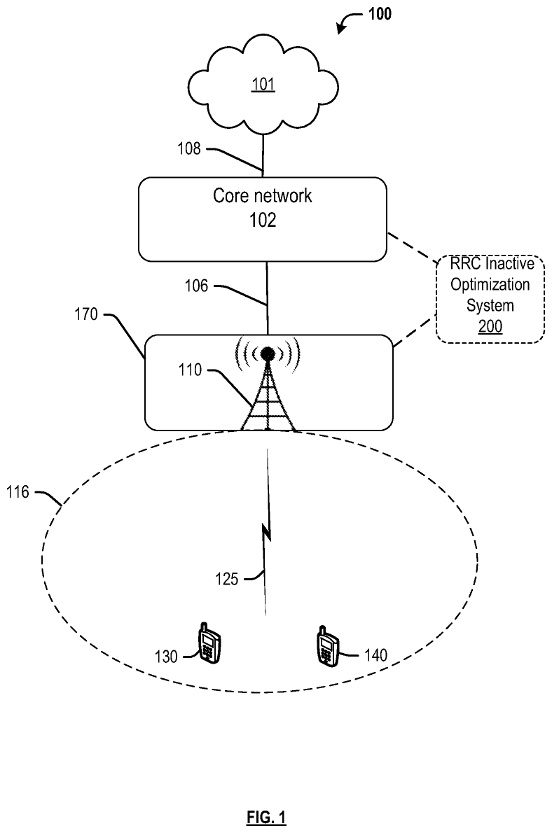

FIG. 1 depicts an exemplary environment 100 for implementing an RRC inactive optimization system 200. Environment 100 comprises a communication network 101, core network 102, and a radio access network (RAN) 170 including at least an access node 110. Wireless devices 130 and 140 communicate with the access node 110. Further, the RRC inactive optimization system 200 is provided to optimize the use of RRC inactive state for the wireless devices 130 and 140. More specifically, the optimization performed by the RRC inactive optimization system 200 optimizes the use of RRC inactive state to benefit the network including the core network 102 and RAN 170 and the wireless devices 130 and 140. Furthermore, components not shown may include, for example, gateway node(s) controller nodes, and additional access nodes.

Access node 110 can be any network node configured to provide communication between end-user wireless devices 130 and 140 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 130 and 140 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to MIMO (including SU-MIMO, MU-MIMO, mMIMO, beamforming, etc.), carrier aggregation (including inter-band and intra-band carrier aggregation), and different duplexing modes including frequency division duplexing (FDD) and time division duplexing (TDD).

Thus, in an exemplary embodiment, wireless devices 130 and 140 may be 5G capable devices and may further support RRC inactive state. However, wireless device 130 may have a first wireless device profile requiring a first QCI and wireless device 140 may have a second wireless device profile requiring a second QCI. In embodiments described herein, the first wireless device 130 with the first QCI is designated as RRC inactive eligible, while the second wireless device 140 is designated as RRC ineligible. Thus, the second wireless device 140 will convert to RRC idle mode after a threshold period of inactivity, whereas the first wireless device 130 will transition to RRC inactive state.

In a further exemplary embodiment, the wireless device 130 is utilizing a first application requiring low latency and the wireless device 140 is utilizing a second application that does not require low latency. Accordingly, the wireless device 130 is assigned to a first network slice providing RRC inactive eligibility and the wireless device 140 is assigned to a second network slice that does not provide RRC inactive eligibility. Thus, the wireless device 130 is RRC inactive eligible and the second wireless device 140 is not eligible for RRC inactive state. Thus, the wireless device 140 will convert to RRC idle mode after a threshold period of inactivity, whereas the wireless device 130 will transition to RRC inactive state. If the wireless devices 130 and 140 change their application use, the network slice and RRC inactive eligibility may also change.

The exemplary operating environment 100 includes the RRC inactive optimization system 200, which determines wireless device eligibility for the RRC inactive state. The RRC inactive optimization system 200 is illustrated as operating between the core network 102 and the RAN 170. However, it should be noted that the RRC inactive optimization system 200 may operate in the core 102, in the RAN 170, or may be distributed. For example, the RRC inactive optimization system 200 may utilize components located at both the core network 102 and at the multiple access nodes 110. Alternatively, the RRC inactive optimization system 200 may be an entirely discrete system operating in conjunction with the RAN 170, core 102 and/or the wireless devices 130 and 140.

The RRC inactive optimization system 200 receives information pertaining to wireless devices from wireless devices 130 and 140. For example, the RRC optimization system 200 may collect performance parameters, location information, capabilities, and identification information. In embodiments set forth herein, the wireless devices 130 and 140 may send these parameters to the access nodes 110, which convey relevant parameters to the RRC inactive optimization system 200. For example, the wireless devices 130 and 140 may send a UE capability report indicating device support for RRC inactive state. Further the wireless devices 130 and 140 may indicate application usage, e.g., whether or not they are using an application requiring low latency. The RRC inactive optimization system 200 analyzes this information in order to determine eligibility of the wireless devices 130, 140 for RRC inactive state. For example, the RRC inactive optimization system 200 may be configured to execute methods including determining a network slice based on application usage and further determining RRC inactive state eligibility based on the determination. Additionally, or alternatively, the RRC inactive optimization system 200 may receive wireless device information that includes a wireless device profile for each of the wireless devices 130 and 140 from the core network 102 (i.e., the AMF of the core network 102) and determine eligibility of the wireless devices 130 and 140 for RRC inactive state based on the received profiles. Thus, exemplary embodiments described herein include instructing wireless devices to use either RRC inactive state or RRC idle mode after a threshold period of inactivity. The instruction is based on a determination of RRC inactive state eligibility as described above.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Further, the access node 110 may communicate with the RRC inactive optimization system 200 or alternatively may wholly or partially incorporate the RRC inactive optimization system 200. Thus, the RRC inactive optimization system 200 may determine the eligibility of each wireless device 130, 140 for the RRC inactive state in order to provide an appropriate instruction to each wireless device, for example through an RRC message.

Wireless devices 130 and 140 may be any device, system, combination of devices, or other such communication platform capable of communicating wirelessly with access node 110 using one or more frequency bands deployed therefrom. Wireless devices 130 and 140 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. As set forth above, the wireless devices 130 and 140 may utilize different applications at different times, which may cause them to be assigned to different network slices. While some network slices will render a wireless device eligible for RRC inactive state, other network slices will render the wireless devices as RRC inactive state ineligible. Further, the wireless devices 130, 140 may be associated with different UE profile parameters rendering them either eligible or ineligible for RRC inactive state.

Subsequent to sending capabilities to the access node 110, for example, through a UE capability information message or through another message, the wireless devices 130 and 140 may receive instructions from the access node 110. The instructions may, for example, instruct the wireless devices 130 and 140 to utilize either RRC inactive state or RRC idle mode. The instruction may be an information element sent via RRC message, in a system information block (SIB) message, or any equivalent means. The instruction can be sent responsive to receiving the service request, or periodically throughout a communication session. The instruction may specify that the wireless device 130 or 140 should utilize RRC inactive state after a threshold period of inactivity or should utilize RRC idle mode after the threshold period of inactivity.

The core network 102 includes core network functions and elements. The core network may have an evolved packet core (EPC) structure or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 130 and 140 and is responsible for handling connection and mobility management tasks. Thus, the AMF may store wireless device profiles including QCI or PLMN information that can be utilized for determination of RRC inactive state eligibility or ineligibility. The SMF is primarily responsible for creating, updating and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 130, 140, etc. Wireless network protocols can comprise MBMS, code division multiple access (CDMA) 1xRTT, Global System for Mobile communications (GSM), Universal Mobile

Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications links 106 may include S1 communications links. Other wireless protocols can also be used. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

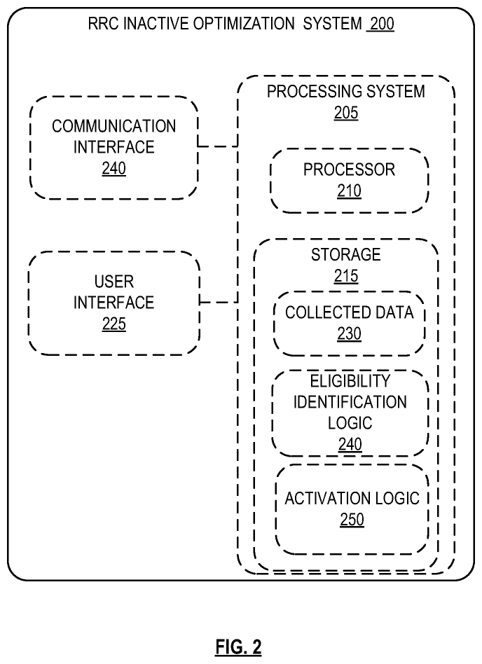

FIG. 2 illustrates an RRC inactive optimization system 200 in accordance with embodiments described herein. The components described herein are merely exemplary as many different configurations for the RRC inactive optimization system 200 may be implemented. The RRC inactive optimization system 200 may be configured to perform the methods and operations disclosed herein to dynamically determine wireless device eligibility for RRC inactive state. In the disclosed embodiments, the RRC inactive optimization system 200 may be integrated with each access node 110, integrated with the core network 102 or may be an entirely separate component capable of communicating with at least the wireless devices 130, 140 and the RAN 170. Further, the components of the RRC inactive optimization system 200 may be distributed so that one or more components are located at an access node 110 and one or more other components are located within a separate processing node or at the core network 102.

The RRC inactive optimization system 200 may be configured for collecting data transmitted by the wireless devices 130, 140 to the access nodes 110. To perform RRC inactive optimization, the RRC inactive optimization system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, eligibility identification logic 240 may store instructions to determine eligibility of various wireless devices 130, 140 to enter RRC inactive state. Further, the memory 215 may store the collected data at 230, which may be or include data collected from the wireless devices 130 and 140, from the RAN 170 or from the core network 102. Additionally, activation logic 250 may be executed to instruct or trigger an instruction to the wireless devices 130, 140 indicating whether to enter RRC inactive state or RRC idle mode after a threshold period of inactivity. To perform the above-described operations, the eligibility identification logic 240 and activation logic 250 may be executed by the processor 210 to operate on the collected data 230 or other data transmitted to the RRC inactive optimization system 200.

Processor 210 may be a microprocessor and may include hardware circuitry and/or embedded codes configured to retrieve and execute software stored in storage device 215. The RRC inactive optimization system 200 further includes a communication interface 220 and a user interface 225. Communication interface 220 may be configured to enable the processing system 205 to communicate with other components, nodes, or devices in the wireless network. For example, the RRC inactive optimization system 200 receives relevant parameters from an access node 110 or from the wireless devices 130, 140 or from the core network 102.

Communication interface 220 may include hardware components, such as network communication ports, devices, routers, wires, antenna, transceivers, etc. User interface 225 may be configured to allow a user to provide input to the RRC inactive optimization system 200 and receive data or information from access nodes 110 or the wireless devices 130 and 140. User interface 225 may include hardware components, such as touch screens, buttons, displays, speakers, etc. The RRC optimization system 200 may further include other components such as a power management unit, a control interface unit, etc.

The location of the RRC inactive optimization system 200 may depend upon the network architecture. As set forth above, the RRC inactive optimization system 200 may be located in an access node 110, in a separate processing node, in the RAN 170, in multiple locations, or may be an entirely discrete component. Further, although shown as a single integrated system, the functions of data collection, eligibility identification or determination, and activation may be separated and disposed in separate locations.

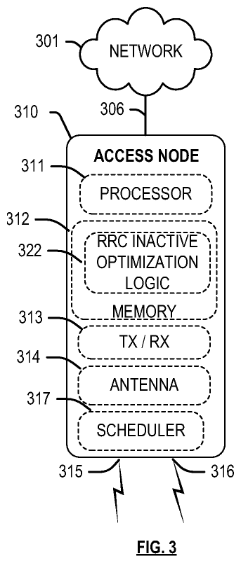

FIG. 3 depicts an exemplary access node 310. Access node 310 is configured as an access point for providing network services from network 301 to end-user wireless devices such as wireless devices 130 and 140 in FIG. 1. Access node 310 is illustrated as comprising a memory 312 for storing logical modules that perform operations described herein, a processor 311 for executing the logical modules, and a transceiver 313 for transmitting and receiving signals via antennas 314. Combinations of antennas 314 and transceivers 313 are configured to deploy a wireless air interface using at least two carriers, each of which uses a different frequency band. Further, the different sets of antennas can be used to implement various transmission modes or operating modes in each sector, including but not limited to MIMO (including SU-MIMO, MU-MIMO, mMIMO, beamforming, etc.), CA, and different duplexing modes including FDD and TDD. Further, access node 310 is communicatively coupled to network 301 via communication interface 306, which may be any wired or wireless link as described above. Scheduler 317 may be provided for scheduling resources based on the presence and performance parameters of the UEs 130 and 140. Wireless communication links 315 and 316 may deploy different duplexing modes including TDD and FDD.

In an exemplary embodiment, memory 312 includes logic 322 for RRC inactive optimization. For example, access node 310 may operate cooperatively with the RRC inactive optimization system 200 described above with respect to FIG. 2. Alternatively, the access node 310 may wholly or partially incorporate the RRC inactive optimization system 200 shown in FIG. 2. For example, the RRC optimization system 200 may trigger instructions from the access node 310 to the wireless devices 130, 140 regarding eligibility or ineligibility for RRC inactive state. Network 301 may be similar to network 101 discussed above.

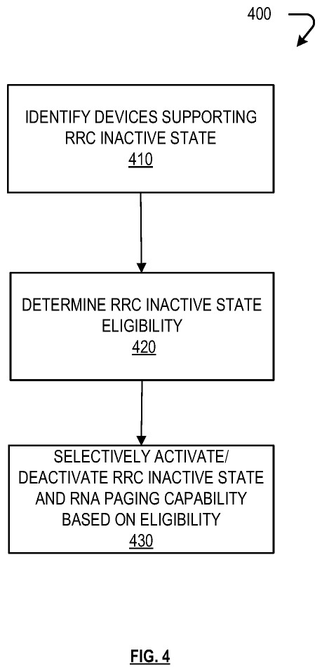

FIG. 4 illustrates an exemplary method 400 for dynamically optimizing RRC inactive state for wireless devices in a network. Method 400 may be performed by any suitable processor discussed herein, for example, a processor included in access node 110 or 310, or a processor included in the RRC inactive optimization system 200. For discussion purposes, as an example, method 400 is described as being performed by the processor 210 of the RRC inactive optimization system 200.

Method 400 starts in step 410, in which the access node 310 may identify that devices in the network support utilization of RRC inactive state. This identification may be achieved based on a UE capability report received from one or more wireless devices. For example, wireless devices may have a particular chipset that allows them to enter RRC inactive state and may report this to the access node.

In step 420, the processor 210 selectively determines whether a wireless device supporting RRC inactive state is eligible to utilize the RRC inactive state. In one embodiment, the processor may determine latency or QoS requirements of the wireless device. In further embodiments, the processor 210 may determine eligibility based on public land mobile network identifier (PLMN-ID). Alternatively, the processor 210 may determine eligibility based on a quality of service (QoS) class identifier (QCI). As a further alternative, the processor 210 may group the wireless devices based on a 5G QoS identifier (5QI). For example, the processor 210 may determine eligibility based on respective single-network slice selection assistance information (S-NSSAI). S-NSSAI is an identifier for a network slice across the 5G core, 5G-RAN and the UE. The S-NSSAI may include a slice service type (SST) and a slice differentiator (SD). SST refers to the expected network slice behavior in terms of features and services. SD complements the SST to differentiate amongst multiple network slices of the same SST. Various combinations of the aforementioned indicators may be utilized by the processor 210 to determine eligibility of the wireless devices for RRC inactive state.

In embodiments set forth herein, in step 430, the processor 210 selectively triggers activation or deactivation of the RRC inactive state and RNA paging capability based on the eligibility determination performed in step 420. For example, for a particular wireless device, the RRC inactive capability may be deactivated when the device does not have a QCI requiring low latency. This is typically true of roaming devices or other devices that belong to specific PLMNs outside of the network and thus are not considered “home” devices. Also, devices utilizing applications that do not require low latency may have their eligibility for RRC inactive state and RNA paging selectively deactivated. However, the same wireless device, utilizing an application that requires low latency, may be deemed eligible for RRC inactive state and RNA paging. Upon activation, RRC inactive eligible wireless devices experiencing a threshold period of inactivity enter RRC inactive state and utilize RNA paging to reconnect. Wireless devices that are ineligible for RRC inactive state, upon experiencing the threshold period of inactivity, may enter RRC idle state and be required to utilize TAC paging to reconnect to the network. The threshold period of inactivity may be configured per network based on network parameters.

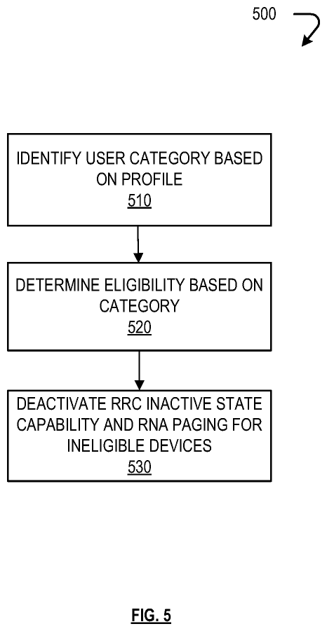

FIG. 5 depicts an exemplary method 500 for determining eligibility or RRC inactive state in accordance with an embodiment. Method 500 may be performed by any suitable processor discussed herein, for example, a processor included in access node 110 or 310, or a processor included in the RRC inactive optimization system 200. For discussion purposes, as an example, method 500 is described as being performed by the processor 210 included in the RRC optimization system 200.

Method 500 starts in step 510, in which the processor 210 identifies a user category based on a user profile. The processor 210 may, for example, retrieve a user profile from the AMF of the core network 102. The user profile may include information such as PLMN-ID and/or QCI for the wireless device. As a further alternative, the user profile may include a 5G QoS identifier (5QI). Various combinations of the aforementioned indicators may be utilized by the processor 210 in order to categorize the wireless devices.

As one example, the processor 210 utilizes QCI to determine a category. QCI is utilized to tag data on cellular networks with a level of priority. The lower the QCI identification number, the higher the priority that data has to complete its network request over other higher tagged QCI traffic. Commonly, cellular data plans provide a QCI ranging from QCI-6 to QCI-9, where QCI-6 data receives the highest priority and QCI-9 data receives the lowest. Accordingly, QCI-6, QCI-7, and QCI-8 network requests are generally completed prior to any QCI-9 request. Typically, customers paying more for cellular plans have the lower QCI and the higher priority.

Further, some mobile device users subscribe to a mobile virtual network operator (MVNO), which is a wireless communications services provider that does not own the wireless network infrastructure over which it provides services to its customers. An MVNO enters into a business agreement with a mobile network operator to obtain bulk access to network services at wholesale rates, then sets retail prices independently. Mobile users gaining access through an MVNO are typically tagged with a lower priority and higher QCI than mobile users subscribing directly to the mobile services provider owning the wireless network infrastructure. Accordingly, while premium subscribers to a network such as AT&T®, Verizon®, or T-Mobile® may be tagged with QCI-6, MVNO subscribers will be tagged with QCI-7, QCI-8, or QCI-9. MVNOs include, for example Cricket Wireless®, Consumer Cellular®, Straight Talk®, Boost®, etc.

Further, in some embodiments, the wireless device may be a HINT device, which deploys a wireless interface for home internet usage. Wireless carriers often tag HINT devices with a particular QCI, which usually indicates a low priority. Accordingly, embodiments provided herein include determining based on the wireless device profile information that the wireless device is a home internet (HINT) device and determining that the HINT device is ineligible for RRC inactive state.

In embodiments set forth herein, in step 520, once the processor 210 categorizes the wireless devices in step 510, it determines eligibility of the wireless device for RRC inactive state and RNA paging based on the category. For example, the wireless devices tagged with QCI 6 may be eligible for RRC inactive state and RNA paging, while wireless devices assigned QCI-7, QCI-8, or QCI-9 may be deemed ineligible. Alternatively, wireless devices assigned QCI-6 and QCI-7 may be eligible for RRC inactive state and wireless devices assigned QCI-8 and QCI-9 may be ineligible for RRC inactive state and RNA paging. Other eligibility models are within scope of the disclosure.

Finally, in step 530, the processor 210 triggers deactivation of RRC inactive eligibility for ineligible devices. Thus, the ineligible wireless devices will be required to enter RRC idle mode rather than RRC inactive state and will utilize TAC paging rather than RNA paging in order to reconnect to the network.

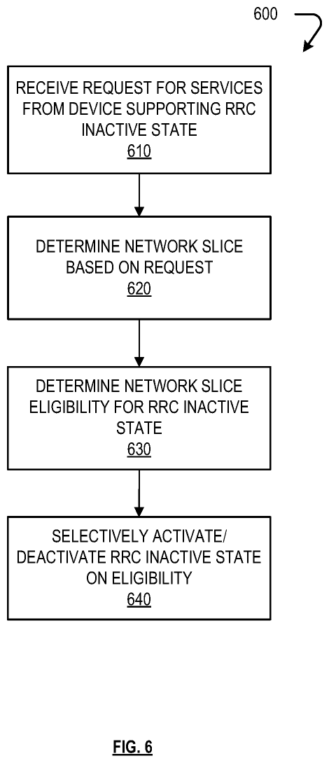

FIG. 6 depicts an additional exemplary method 600 for RRC inactive optimization in accordance with an embodiment. Method 600 may be performed by any suitable processor discussed herein, for example, a processor included in access node 110 or 310, or the processor 210 included in the RRC inactive optimization system 200. For discussion purposes, as an example, method 500 is described as being performed by the processor 210 included in the RRC optimization system 200.

In step 610, the processor 210 may receive a request for services from a wireless device supporting RRC inactive state. The request may be or include a request to use a particular application. For example, the request may be either for a service that does not require low latency or for a service that does require low latency. While most applications do not require low latency, applications such as streaming video, gaming, voice over new radio (VoNR), industrial automation, or autonomous vehicle applications typically do require low latency. Further, these applications may be associated with a particular QoS level aimed at providing a smooth and uninterrupted experience.

In step 620, the processor 210 may determine a network slice based on the particular service requested through the request received in step 610. For example, the processor 210 may determine the network slice based on whether the requested service requires low latency or has a particular QoS associated with it. For example, multiple network slices may be provided for different low latency applications. Network slicing enables the creation of separate virtualized sub-networks that can be tailored to meet the specific requirements of different applications. The processor 210 may determine to which network slice the request should be assigned. Thus, applications requiring latency below a particular predetermined threshold, which may be specific to the network, may be assigned to network slices allowing RRC inactive state.

As a further alternative, in step 610, a wireless device, such as the wireless device 130 or 140 may have a universal integrated circuit card (UICC) that stores the credentials of the slice it is authorized to use. Thus, when the wireless device connects to the network, it will use the credentials to authenticate with the network and request access to a specific slice. The specific slice may, for example, correspond to subscriber credentials and may distinguish, for example, between an MVNO subscriber and a non-MVNO subscriber.

In step 630, the processor 210 may determine whether the network slice indicates an eligibility for RRC inactive state and RNA paging. For example, the processor 210 may group the wireless devices based on respective single-network slice selection assistance information (S-NSSAI). S-NSSAI is an identifier for a network slice across the 5G core, 5G-RAN and the wireless device. The S-NSSAI may include a slice service type (SST) and a slice differentiator (SD). SST refers to the expected network slice behavior in terms of features and services. SD complements the SST to differentiate amongst multiple network slices of the same SST.

Accordingly, in step 640, the processor 210 selectively activates or deactivates RRC inactive capabilities of the wireless device based on network slice eligibility. Wireless devices eligible to utilize RRC inactive state also use RNA paging and wireless devices ineligible to use RRC inactive state will utilize RRC idle mode, will not store connection parameters, and will be required to reconnect to the network using TAC paging.

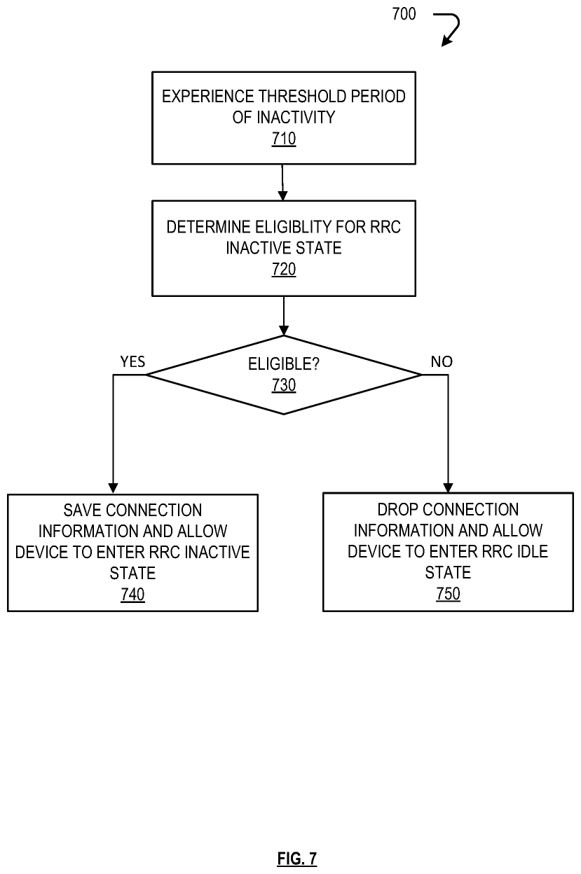

FIG. 7 depicts an additional exemplary method 700 for implementing RRC inactive optimization. Method 700 may be performed by any suitable processor discussed herein, for example, a processor included in access node 110 or 310 or the processor 210 included in the RRC inactive optimization system 200. For discussion purposes, as an example, method 700 is described as being performed by the processor 210.

In step 710, the processor detects that a wireless device, such as the wireless device 130 or 140, has experienced a threshold period of inactivity. The threshold may be network specific and may be determined based on network parameters. When the threshold period has been reached, the processor 210 determines eligibility of a requesting wireless device, such as the wireless device 130 or 140 for RRC inactive state in step 620. The eligibility may be determined based on wireless device category or network slice as described above.

If the wireless device is determined to be RRC inactive eligible in step 730, then the wireless device and the processor 210 retain connection information and allow the wireless device to enter RRC inactive state in step 740. Accordingly, when the wireless device reconnects to the network, it will utilize saved connection information and RNA paging.

Alternatively, if in step 730, the wireless device is deemed RRC inactive ineligible, then both the network and the wireless device drop connection information and the wireless device enters RRC idle mode in step 750.

Accordingly, as set forth above, embodiments provided herein optimize RRC inactive usage by allowing only some wireless devices to enter RRC inactive state. The devices entering RRC inactive state are able to refresh the connection utilizing RNA paging. Methods disclosed herein prohibit other devices from utilizing RRC inactive state, forcing them to drop connection information and to enter RRC idle mode. These devices will be prohibited from using RNA paging and therefore will utilize TAC paging to reconnect to the network.

In some embodiments, methods 400, 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
identifying a wireless device supporting a radio resource configuration (RRC) inactive state;
determining, based on a wireless device profile or an active application utilized by the wireless device that the wireless device is not eligible to utilize the RRC inactive state; and
selectively deactivating a capability for RRC inactive state and RNA paging for the wireless device based on the determination.

2. The method of claim 1, wherein the determining based on the wireless device profile comprises:
receiving wireless device profile information from a core network; and
determining, based on the wireless device profile information that the wireless device is not eligible to utilize RRC inactive state.

3. The method of claim 2, further comprising determining from the wireless device profile information whether the wireless device is associated with a subscriber or a mobile virtual network operator (MVNO).

4. The method of claim 2, further comprising determining based on the wireless device profile information that the wireless device is a home internet (HINT) device.

5. The method of claim 2, further comprising determining a quality of service class identifier (QCI) for the wireless device based on the wireless device profile.

6. The method of claim 5, further comprising determining based on the QCI whether the wireless device is eligible to utilize the RRC inactive state and RNA paging.

7. The method of claim 1, further comprising determining the active application does not require low latency.

8. The method of claim 7, further comprising associating the active application with a network slice.

9. The method of claim 8, further comprising activating the network slice associated with the active application, wherein the network slice does not enable RRC inactive state or RNA paging and enables RRC idle mode and a paging area defined by a tracking area code (TAC).

10. A system comprising:
at least one communication interface;
a memory storing instructions;
a processor executing the stored instructions to perform operations including;
identifying a wireless device supporting a radio resource configuration (RRC) inactive state;
selectively deactivating an RRC inactive state capability based on wireless device information; and
utilizing RRC idle mode and a paging area defined by a tracking area code (TAC) for the wireless device upon deactivation of the RRC inactive state capability.

11. The system of claim 10, wherein the wireless device information comprises wireless device profile information, the operations further comprising
receiving the wireless device profile information from a core network; and
determining, based on the wireless device profile information whether the wireless device is eligible to utilize the RRC inactive state and radio notification area (RNA) paging.

12. The system of claim 11, the operations further comprising determining a quality of service class identifier (QCI) for the wireless device based on the wireless device profile information.

13. The system of claim 12, the operations further comprising determining based on the QCI whether the wireless device is eligible to utilize the RRC inactive state and RNA paging.

14. The system of claim 10, the operations further comprising determining an active application of the wireless device.

15. The system of claim 14, the operations further comprising associating the active application with a network slice.

16. The system of claim 15, the operations further comprising activating the network slice associated with the active application, wherein the network slice does not enable the RRC inactive state or RNA paging and enables RRC idle mode and a TAC paging area.

17. A method comprising:
identifying a wireless device supporting a radio resource configuration (RRC) inactive state;
selectively deactivating RRC inactive capability for the wireless device based on wireless device information; and
triggering a transition of the wireless device to RRC idle mode at least upon deactivating the RRC inactive capability.

18. The method of claim 17, further comprising detecting a threshold period of inactivity, wherein triggering includes triggering the transition of the wireless device to RRC idle mode upon deactivating the RRC inactive capability and after the threshold period of inactivity.

19. The method of claim 17, wherein the wireless device information comprises latency requirements for an active application or QCI information from a wireless device profile.

20. The method of claim 19, further comprising associating the latency requirements with a network slice.
